(19) United States
(12) Patent Application Publication
(10) Pub. No.: US 2026/0246954 A1
(43) Pub. Date: Aug. 20, 2026

(54) HARDWARE IMPLEMENTATION OF IMAGE CODING

(71) Applicant: V-NOVA INTERNATIONAL LIMITED, London (GB)

(72) Inventors: Obioma OKEHIE, London (GB); Adrien LE MASLE, London (GB)

(21) Appl. No.: 19/469,510

(22) PCT Filed: Mar. 6, 2024
(86) PCT No.: PCT/GB2024/050594

§ 371 Date: Sep. 26, 2025

(30) Foreign Application Priority Data
Mar. 30, 2023 (GB) 2304685.7

(51) Int. Cl. H04N 19/42; H04N 19/60

(52) U.S. Cl. CPC H04N 19/42; H04N 19/60

(57) ABSTRACT

There is provided a hardware block for converting input data elements representing image data in a first format to output data elements representing image data in a second format. The hardware block comprises a plurality of modules organised into a first group of modules and a second group of modules. Each module of the first group of modules is configured to: receive a subset of the input data elements in the first format; and perform a plurality of operations to convert the subset of the input data elements in the first format to intermediate elements. Each intermediate element is derived from the subset of the input data elements in the first format using one of the plurality of operations; and wherein each module of the second group of modules is configured to: receive a subset of the intermediate elements, wherein each intermediate element of the received subset of the intermediate elements is from a different module of the first group of modules; and perform the plurality of operations to convert the subset of the intermediate elements to a subset of the output data elements in the second format.

### TECHNICAL FIELD

This disclosure relates to a hardware implementation for converting input data elements in a first format to output data elements in a second format. Particularly, but not exclusively, the invention relates to a hardware implementation for converting input data elements representing image data in a first format to output data elements representing image data in a second format.

### BACKGROUND

Image coding processes can be implemented either in software or hardware, and while software implementation is relatively straightforward, hardware implementation provides significant advantages in terms of speed and performance.

A hardware implementation of image coding can provide quicker encoding and decoding of image data compared to software implementation. This is because hardware implementation can be specifically designed to perform specific image coding tasks and optimised to provide faster processing times. For many use cases, a basic or obvious hardware implementation is sufficient, but for high-demand applications, such as high resolution or high frame rate image coding, more advanced hardware implementations are required.

However, implementing image coding in hardware also comes with its own set of challenges. High-demand applications often translate into high costs in terms of resources and processing time, as the hardware needs to be capable of handling the large amounts of data. In addition, image coding often involves the use of transform operation to transform image data from one format to a different format. The type of transform required can change between frames and even within a frame, which makes it challenging to build a hardware implementation that is capable of performing such transformations. To address these challenges, there is a need for an optimised hardware implementation that can perform image coding efficiently, with reduced costs, and with the ability to handle multiple transforms.

Another challenge in hardware implementation is that high-resolution and high frame rate applications require significant resources, both in terms of area and processing power. This can result in high costs for the device, and in many cases, the cost becomes prohibitive for low-cost devices. To overcome this challenge, it is necessary to design an optimised hardware implementation that can perform image coding efficiently, using the minimum amount of resources, while still meeting the performance requirements.

### SUMMARY

According to a first aspect of the invention, there is provided a hardware block for converting input data elements representing image data in a first format to output data elements representing image data in a second format. The hardware block comprises a plurality of modules organised into a first group of modules and a second group of modules. Each module of the first group of modules is configured to: receive a subset of the input data elements in the first format; and perform a plurality of operations to convert the subset of the input data elements in the first format to intermediate elements. Each intermediate element is derived from the subset of the input data elements in the first format using one of the plurality of operations; and wherein each module of the second group of modules is configured to: receive a subset of the intermediate elements, wherein each intermediate element of the received subset of the intermediate elements is from a different module of the first group of modules; and perform the plurality of operations to convert the subset of the intermediate elements to a subset of the output data elements in the second format.

Preferably, wherein the plurality of modules are each configured to perform the same operations.

Preferably, wherein, based on an indicator received at the hardware block, the intermediate elements derived by at least one module of the first group of modules is outputted from the hardware block without being sent to the second group of modules.

Preferably, wherein each intermediate element is derived from the subset of the input data elements in the first format using a distinct one of the plurality of operations.

Preferably, wherein each received subset of the intermediate elements is derived from the subset of the input data elements in the first format using the same distinct one of the plurality operations.

Preferably, wherein the input data elements in the first format are residual elements and the output data elements in the second format are a set of transformed elements indicative of an extent of spatial correlation in the residual elements.

Preferably, wherein the output data elements in the second format are residual elements and the input data elements in the first format are a set of transformed elements indicative of an extent of spatial correlation in the residual elements.

Preferably, wherein the set of transformed elements indicate one or more of average, horizontal, vertical and diagonal relationship between neighbouring residual elements.

Preferably, wherein the set of transformed elements are based on a Hadamard direct decomposition transform.

Preferably, wherein the residual elements are based on a difference between a first rendition of an image associated with the image data at a level of quality in a tiered hierarchy having multiple levels of quality and a second rendition of the image at the same level of quality.

Preferably, wherein each of the plurality of operations perform a multi-dimensional Hadamard direct decomposition transform.

Preferably, wherein the subset of the input data elements in the first format and subset of the output data elements in the second format each comprise four data elements.

Preferably, wherein the first group of modules and the second group of modules each comprise four modules.

Preferably, wherein the first group of modules and the second group of modules are the same.

Preferably, wherein the intermediate element derived in at least one module of the first group of modules is outputted from the hardware block.

Preferably, wherein the intermediate element derived in at least one module of the first group of modules is outputted from the hardware block in response to the hardware block receiving an indicator.

Preferably, the indicator may be derived from information contained in a bitstream received at the hardware.

Preferably, wherein the bitstream comprises input data elements and metadata.

Preferably, the metadata comprises the information used to derive the indicator.

According to a second aspect of the invention, there is provided a method for converting input data elements representing image data in a first format to output data elements representing image data in a second format. The method comprises using a plurality of modules organised into a first group of modules and a second group of modules. The method further comprises at each module of the first group of modules: receiving a subset of the input data elements in the first format; and performing a plurality of operations to convert the subset of the input data elements in the first format to intermediate elements. Each intermediate element is derived from the subset of the input data elements in the first format using one of the plurality of operations. The method further comprises at each module of the second group of modules: receiving a subset of the intermediate elements, wherein each intermediate element of the received subset of the intermediate elements is from a different module of the first group of modules; and performing the plurality of operations to convert the subset of the intermediate elements to a subset of the output data elements in the second format.

Preferably, wherein each intermediate element is derived from the subset of the input data elements in the first format using a distinct one of the plurality of operations.

Preferably, wherein each received subset of the intermediate elements is derived from the subset of the input data elements in the first format using the same distinct one of the plurality operations.

Preferably, wherein the input data elements in the first format are residual elements and the output data elements in the second format are a set of transformed elements indicative of an extent of spatial correlation in the residual elements.

Preferably, wherein the output data elements in the second format are residual elements and the input data elements in the first format are a set of transformed elements indicative of an extent of spatial correlation in the residual elements.

Preferably, wherein the set of transformed elements indicate one or more of average, horizontal, vertical and diagonal relationship between neighbouring residual elements.

Preferably, wherein the set of transformed elements are based on a Hadamard direct decomposition transform.

Preferably, wherein the residual elements are based on a difference between a first rendition of an image associated with the image data at a level of quality in a tiered hierarchy having multiple levels of quality and a second rendition of the image at the same level of quality.

Preferably, wherein each of the plurality of operations perform a multi-dimensional Hadamard direct decomposition transform.

Preferably, wherein the subset of the input data elements in the first format and subset of the output data elements in the second format each comprise four data elements.

Preferably, wherein the first group of modules and the second group of modules are the same.

Preferably, wherein the intermediate element derived in at least one module of the first group of modules is outputted from the hardware block.

Preferably, wherein the intermediate element derived in at least one module of the first group of modules is outputted from the hardware block in response to the hardware block receiving an indicator.

Preferably, the indicator may be derived from information contained in a bitstream received at the hardware.

Preferably, the bitstream comprises input data elements and metadata.

Preferably, the metadata comprises the information used to derive the indicator.

### BRIEF DESCRIPTION OF THE DRAWINGS

The invention shall now be described, by way of example only, with reference to the accompanying drawings in which:

FIG. 1 shows an example of how encoded data for one Level of Quality—LOQ-1—is generated at an encoding device;

FIG. 2 shows an example of how LOQ-0 is generated at an encoding device;

FIG. 3 shows schematically an example of how the decoding process is performed;

FIG. 4 illustrates two directional decomposition (e.g. Hadamard) transforms in a conversion process;

FIG. 5 is a block diagram showing an exemplary hardware arrangement to implement the DD transform or iDD transform of FIG. 4;

FIG. 6 illustrates possible hardware blocks which may be used to perform the operation of converting the residual data to AHVD coefficient AA;

FIG. 7 illustrates possible hardware blocks which may be used to perform the operation of converting the residual data to AHVD coefficient AH;

FIG. 8 illustrates possible hardware blocks which may be used to perform the operation of converting AHVD coefficients to a residual data element;

FIG. 9 illustrates possible hardware blocks which may be used to perform the operation of converting AHVD_4×4 coefficients to another residual data element;

FIG. 10 illustrates a modular design of a dd_common module;

FIG. 11 illustrates dd_common modules arranged to perform a DDs transform; and

FIG. 12 illustrates the dd_common modules arrangement of FIG. 11 in an example where an iDDs transform is performed.

### DETAILED DESCRIPTION

The methods of hierarchically encoding a frame that are described herein include generating residuals for a full frame, and then a decimated frame and so on. Different levels in the hierarchy may relate to different resolutions, referred to herein as Levels of Quality—LOQs—and residual data may be generated for different levels. In examples, video compression residual data for a full-sized video frame may be termed as “LOQ-0” (for example, 1920×1080 for a High-Definition—HD—video frame), while that of the decimated frame may be termed “LOQ-x”. In these cases, “x” denotes the number of hierarchical decimations. In certain examples described herein, the variable “x” has a maximum value of one and hence there are exactly two hierarchical levels for which compression residuals will be generated (e.g. x=0 and x=1).

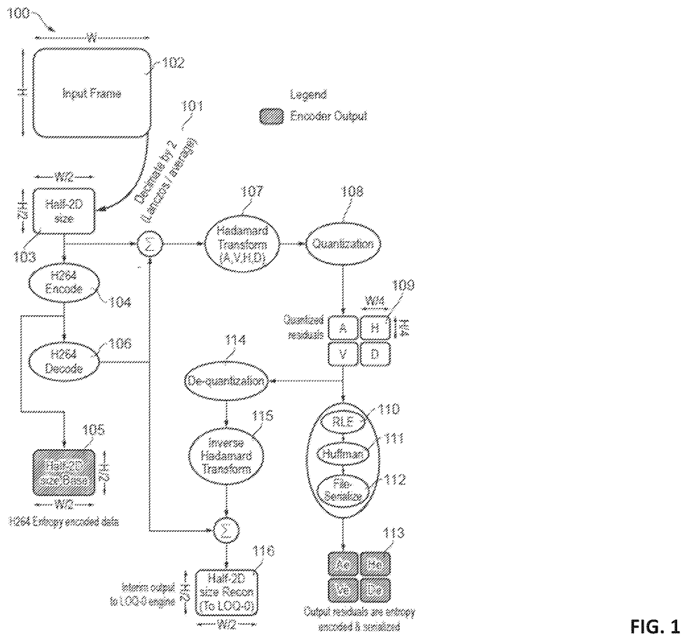

FIG. 1 shows an example of how encoded data for one Level of Quality—LOQ-1—is generated at an encoding device.

The overall algorithm and methods are described using an AVC/H.264 encoding/decoding algorithm as an example baseline algorithm. However, other encoding/decoding algorithms can be used as baseline algorithms without any impact to the way the overall algorithm works. FIG. 1 shows the process 100 of generating entropy-encoded residuals for the LOQ-1 hierarchy level.

The first step 101 is to decimate an incoming, uncompressed video by a factor of two. However, other factors may be used to decimate and/or scale the incoming, uncompressed video. This may involve down-sampling an input frame 102 (labelled “Input Frame” in FIG. 1) having height H and width W to generate a decimated frame 103 (labelled “Half-2D size” in FIG. 1) having height H/2 and width W/2. The down-sampling process involves the reduction of each axis by a factor of two and is effectively accomplished via the use of 2×2 grid blocks. Down-sampling can be done in various ways, examples of which include, but are not limited to, averaging and Lanczos resampling.

The decimated frame 103 is then passed through a base coding algorithm (in this example, an AVC/H.264 coding algorithm) where an entropy-encoded reference frame 105 (labelled “Half-2D size Base” in FIG. 1) having height H/2 and width W/2 is then generated by an entity 104 labelled “H.264 Encode” in FIG. 1 and stored as H.264 entropy-encoded data. However, other scaling factors may be used depending on a scaling mode. The entity 104 may comprise an encoding component of a base encoder-decoder, e.g., a base codec or base encoding/decoding algorithm. A base encoded data stream may be output as entropy-encoded reference frame 105, where the base encoded data stream is at a lower resolution than an input data stream that supplies input frame 102.

In the present example, an encoder then simulates a decoding of the output of entity 104. A decoded version of the encoded reference frame 105 is then generated by an entity 106 labelled “H.264 Decode” in FIG. 1. Entity 106 may comprise a decoding component of a base codec. The decoded version of the encoded reference frame 105 may represent a version of the decimated frame 103 that would be produced by a decoder following receipt of the entropy-encoded reference frame 105.

In the example of FIG. 1, a difference between the decoded reference frame output by entity 106 and the decimated frame 103 is computed. This difference is referred to herein as “LOQ-1 residuals”. The difference forms an input to a transform block 107.

The transform (in this example, a Hadamard-based transform) used by the transform block 107 converts the difference into four components. The transform block 107 may perform a directed (or directional) decomposition to produce a set of coefficients or components that relate to different aspects of a set of residuals. In FIG. 1, the transform block 107 generates A (average), H (horizontal), V (vertical) and D (diagonal) coefficients. The transform block 107 in this case exploits directional correlation between the LOQ-1 residuals, which has been found to be surprisingly effective in addition to, or as an alternative to, performing a transform operation for a higher level of quality—an LOQ-0 level. The LOQ-0 transform is described in more detail below. In particular, it has been identified that, in addition to exploiting directional correlation at LOQ-0, directional correlation can also be present and surprisingly effectively exploited at LOQ-1 to provide more efficient encoding than exploiting directional correlation at LOQ-0 alone, or not exploiting directional correlation at LOQ-0 at all.

The coefficients (A, H, V and D) generated by the transform block 107 are then quantized by a quantization block 108. Quantization may be performed via the use of variables called “step-widths” (also referred to as “step-sizes”) to produce quantized transformed residuals 109. In one example, each quantized transformed residual 109 has a height H/4 and width W/4. For example, if a 4×4 block of an input frame is taken as a reference, each quantized transformed residual 109 may be one pixel in height and width. However, other scaling factors may be used depending on a scaling mode. Quantization involves reducing the decomposition components (A, H, V and D) by a pre-determined factor (step-width). Reduction may be actioned by division, e.g., dividing the coefficient values by a step-width, e.g. representing a bin-width for quantization. Quantization may generate a set of coefficient values having a range of values that is less than the range of values entering quantization block 108 (e.g., transformed values within a range of 0 to 21 may be reduced using a step-width of 7 to a range of values between 0 and 3). In a hardware implementation, an inverse of a set of step-width values can be pre-computed and used to perform the reduction via multiplication, which may be faster than division (e.g., multiplying by the inverse of the step-width).

The quantized residuals 109 are then entropy-encoded in order to remove any redundant information. Entropy encoding may involve, for example, passing the data through a run-length encoder (RLE) 110 followed by a Huffman encoder 111.

The quantized, encoded components (Ae, He, Ve and De) are then placed within a serial stream with definition packets inserted at the start of the stream. The definition packets may also be referred to as header information. Definition packets may be inserted per frame. This final stage may be accomplished using a file serialization routine 112. The definition packet data may include information such as the specification of the Huffman encoder 111, the type of up-sampling to be employed, whether or not A and D coefficients are discarded, and other information to enable the decoder to decode the streams. The output residuals data 113 are therefore entropy-encoded and serialized.

Both the reference data 105 (the half-sized, baseline entropy-encoded frame) and the entropy-encoded LOQ-1 residuals data 113 are generated for decoding by the decoder during a reconstruction process. In one case the reference data 105 and the entropy-encoded LOQ-1 residuals data 113 may be stored and/or buffered. The reference data 105 and the entropy-encoded LOQ-1 residuals data 113 may be communicated to a decoder for decoding.

In the example of FIG. 1, a number of additional operations are performed in order to produce a set of residuals at another (e.g., higher) level of quality—LOQ-0. In FIG. 1, a number of decoder operations for the LOQ-1 stream are simulated at the encoder.

First, the quantized output 109 is branched off and reverse quantization 114 (or “de-quantization”) is performed. This generates a representation of the coefficient values output by the transform block 107. However, the representation output by the de-quantization block 109 will differ from the output of the transform block 107, as there will be errors introduced due to the quantization process. For example, multiple values in a range of 7 to 14 may be replaced by a single quantized value of 1 if the step-width is 7. During de-quantization, this single value of 1 may be de-quantized by multiplying by the step-width to generate a value of 7. Hence, any value in the range of 8 to 14 will have an error at the output of the de-quantization block 109. As the higher level of quality LOQ-0 is generated using the de-quantised values (e.g., including a simulation of the operation of the decoder), the LOQ-0 residuals may also encode a correction for a quantization/de-quantization error and any errors due to any downsampling/upsampling operations which may remove certain frequency components of the image depending on the filter characteristics associated with the downsampling/upsampling operations.

Second, an inverse transform block 115 is applied to the de-quantized coefficient values output by the de-quantization block 114. The inverse transform block 115 applies a transformation that is the inverse of the transformation performed by transform block 107. In this example, the transform block 115 performs an inverse Hadamard transform, although other transformations may be used. The inverse transform block 115 converts de-quantised coefficient values (e.g., values for A, H, V and D in a coding block or unit) back into corresponding residual values (e.g. representing a reconstructed version of the input to the transform block 107). The output of inverse transform block 115 is a set of reconstructed LOQ-1 residuals (e.g., representing an output of a decoder decoding process of LOQ-1). The reconstructed LOQ-1 residuals are added to the decoded reference data (e.g., the output of decoding entity 106) in order to generate a reconstructed video frame 116 (labelled “Half-2D size Recon (To LOQ-0)” in FIG. 1) having height H/2 and width W/2 (other scaling factors may be used depending on a scaling mode.). The reconstructed video frame 116 closely resembles the originally decimated input frame 103, as it is reconstructed from the output of the decoding entity 106 but with the addition of the LoQ-1 reconstituted residuals. The reconstructed video frame 116 is an interim output to an LOQ-0 engine. This process mimics the decoding process and hence is why the originally decimated frame 103 is not used. Adding the reconstructed LOQ-1 residuals to the decoded base stream, i.e., the output of decoding entity 106, allows the LOQ-0 residuals to also correct for errors that are introduced into the LOQ-1 stream by quantization (and in certain cases the transformation), e.g. as well as errors that relate to down-sampling and up-sampling.

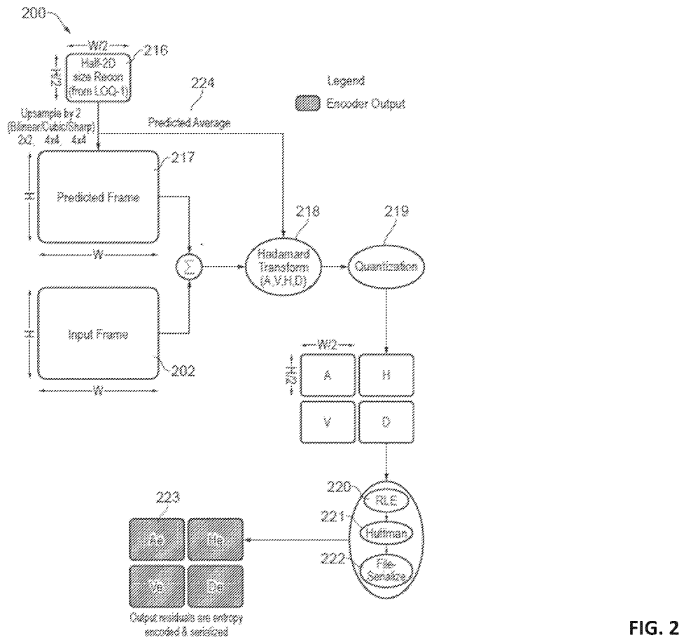

FIG. 2 shows an example of how LOQ-0 is generated 200 at an encoding device.

In order to derive the LOQ-0 residuals, the reconstructed LOQ-1 sized frame 216 (labelled “Half-2D size Recon (from LOQ-1)” in FIG. 2) is derived as described above with reference to FIG. 1. For example, the reconstructed LOQ-1 sized frame 216 comprises the reconstructed video frame 116.

The next step is to perform an up-sampling of the reconstructed frame 216 to full size, WxH. In this example, the upscaling is by a factor of two. At this point, various algorithms may be used to enhance the up-sampling process, examples of which include, but are not limited to, nearest, bilinear, sharp or cubic algorithms. The reconstructed, full-size frame 217 is labelled as a “Predicted Frame” in FIG. 2 as it represents a prediction of a frame having a full width and height as decoded by a decoder. The reconstructed, full-size frame 217 having height H and width W is then subtracted from the original uncompressed video input 202, which creates a set of residuals, referred to herein as “LOQ-0 residuals”. The LOQ-0 residuals are created at a level of quality (e.g., a resolution) that is higher than the LOQ-1 residuals.

Similar to the LOQ-1 process described above, the LOQ-0 residuals are transformed by a transform block 218. This may comprise using a directed decomposition such as a Hadamard transform to produce A, H, V and D coefficients or components. The output of the transform block 218 is then quantized via quantization block 219. This may be performed based on defined step-widths as described for the first level of quality (LOQ-1). The output of the quantization block 219 is a set of quantised coefficients, and in FIG. 2 these are then entropy-encoded 220, 221 and file-serialized 222. Again, entropy-encoding may comprise applying run-length encoding 220 and Huffman encoding 221. The output of the entropy encoding is a set of entropy-encoded output residuals 223. These form a LOQ-0 stream, which may be output by the encoder as well as the LOQ-1 stream (i.e., 113) and the base stream (i.e. 105). The streams may be stored and/or buffered, prior to later decoding by a decoder.

As can be seen in FIG. 2, a “predicted average” component 224 (described in more detail below and denoted A_{enc} below) can be derived using data from the (LOQ-1) reconstructed video frame 116 prior to the up-sampling process. This may be used in place of the A (average) component within the transform block 218 to further improve the efficiency of the coding algorithm.

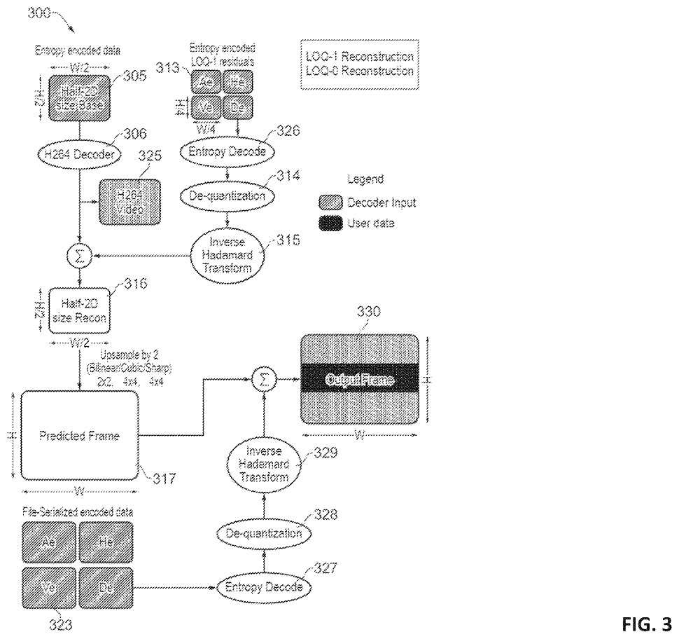

FIG. 3 shows schematically an example of how the decoding process 300 is performed. This decoding process 300 may be performed by a decoder.

The decoding process 300 begins with three input data streams. The decoder input thus consists of entropy-encoded data 305, the LOQ-1 entropy-encoded residuals data 313 and the LOQ-0 entropy-encoded residuals data 323 (represented in FIG. 3 as file-serialized encoded data). The entropy-encoded data 305 includes the reduced-size encoded base, e.g., data 105 as output in FIG. 1. The entropy-encoded data 305 is, for example, half-size, with dimensions W/2 and H/2 with respect to the full frame having dimensions W and H.

The entropy-encoded data 305 are decoded by a base decoder 306 using the decoding algorithm corresponding to the algorithm which has been used to encode those data (in this example, an AVC/H.264 decoding algorithm). This may correspond to the decoding entity 106 in FIG. 1. At the end of this step, a decoded video frame 325, having a reduced size (for example, half-size) is produced (indicated in the present example as an AVC/H.264 video). This may be viewed as a standard resolution video stream.

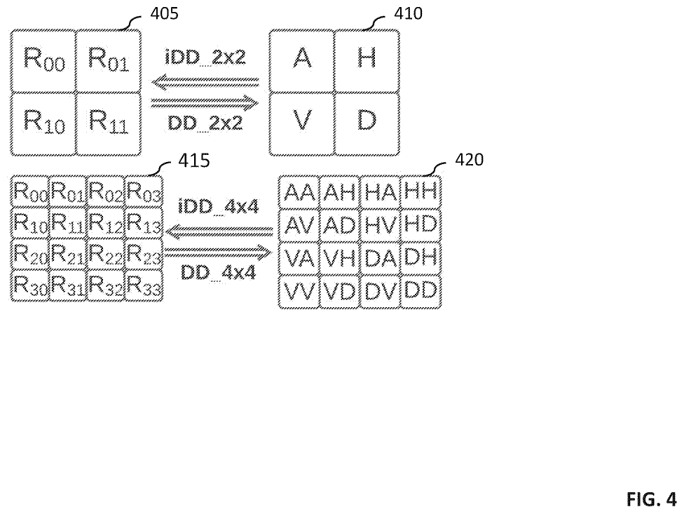

In parallel, the LOQ-1 entropy-encoded residuals data 313 are decoded. As explained above, the LOQ-1 residuals are encoded into four components (A, V, H and D) which, as shown in FIG. 3, have a dimension of one quarter of the full frame dimension, namely W/4 and H/4. This is because, as also described below and in previous patent application U.S. Ser. No. 13/893,669 and PCT/EP2013/059847, the contents of which are incorporated herein by reference, the four components contain all the information associated with a particular direction within the untransformed residuals (e.g., the components are defined relative to a block of untransformed residuals). As described above, the four components may be generated by applying a 2×2 transform kernel to the residuals whose dimension, for LOQ-1, would be W/2 and H/2, in other words the same dimension as the reduced-size, entropy-encoded data 305. In the decoding process 300, as shown in FIG. 4, the four components are entropy-decoded at entropy decode block 326, then de-quantized at de-quantization block 314 before an inverse transform is applied via inverse transform block 315 to generate a representation of the original LOQ-1 residuals (e.g., the input to transform block 107 in FIG. 1). The inverse transform may comprise a Hadamard inverse transform, e.g., as applied on a 2×2 block of residuals data. The de-quantization block 314 is the reverse of the quantization block 108 described above with reference to FIG. 1.

At this stage, the quantized values (i.e., the output of the entropy decode block 326) are multiplied by the step-width (i.e. stepsize) factor to generate reconstructed transformed residuals (i.e. components or coefficients). It may be seen that blocks 114 and 115 in FIG. 1 mirror blocks 314 and 315 in FIG. 3.

The decoded LOQ-1 residuals, e.g., as output by the inverse transform block 315, are then added to the decoded video frame, e.g. the output of base decode block 306, to produce a reconstructed video frame 316 at a reduced size (in this example, half-size), identified in FIG. 3 as “Half-2D size Recon”. This reconstructed video frame 316 is then up-sampled to bring it up to full resolution (e.g., the 0th level of quality from the 1st level of quality) using an up-sampling filter such as bilinear, bicubic, sharp, etc. In this example, the reconstructed video frame 316 is up-sampled from half width (W/2) and half height (H/2) to full width (W) and full height (H)).

The up-sampled reconstructed video frame 317 will be a predicted frame at LOQ-0 (full-size, W×H) to which the LOQ-0 decoded residuals are then added.

In FIG. 3, the LOQ-0 encoded residual data 323 are decoded using an entropy decode block 327, a de-quantization block 328 and an inverse transform block 329. As described above, the LOQ-0 residuals data 323 are encoded using four components (i.e., are transformed into A, V, H and D components) which, as shown in FIG. 3, have a dimension of half the full frame dimension, namely W/2 and H/2. This is because, as described herein and in previous patent application U.S. Ser. No. 13/893,669 and PCT/EP2013/059847, the contents of which are incorporated herein by reference, the four components contain all the information relative to the residuals and are generated by applying a 2×2 transform kernel to the residuals whose dimension, for LOQ-0, would be W and H, in other words the same dimension of the full frame. The four components are entropy-decoded by the entropy decode block 327, then de-quantized by the de-quantization block 328 and finally transformed 329 back into the original LOQ-0 residuals by the inverse transform block 329, transform (e.g., in this example, a 2×2 Hadamard inverse transform).

The decoded LOQ-0 residuals are then added to the predicted frame 317 to produce a reconstructed full video frame 330. The frame 330 is an output frame, having height H and width W. Hence, the decoding process 300 in FIG. 3 is capable of outputting two elements of user data: a base decoded video stream 325 at the first level of quality (e.g., a half-resolution stream at LOQ-1) and a full or higher resolution video stream 330 at a top level of quality (e.g. a full-resolution stream at LOQ-0).

The above description has been made with reference to specific sizes and baseline algorithms. However, the above methods apply to other sizes and/or baseline algorithms.

The above description is only given by way of example of the more general concepts described herein.

FIG. 4 illustrates two directional decomposition (e.g., Hadamard) transforms in a conversion process.

The aim of the conversion process is to convert residuals to directional decomposed values (forward transform) and convert the directional decomposed values back into the original residuals (inverse transform). As mentioned regarding FIGS. 1 to 3, the residuals are the values which are derived by subtracting the reconstructed video frame from the ideal input (or down-sampled) frame.

First, FIG. 4 illustrates a 2×2 residual data block 405 and corresponding 2×2 AHVD coefficients block 410 as mentioned above. The 2×2 AHVD coefficients block 410 is derivable from the 2×2 residual data block 405 using a forward 2×2 Hadamard transform DD_2×2 (DD transform). The 2×2 residual data block 405 is derivable from the 2×2 AHVD coefficients block 410 using a reverse or inverse 2×2 Hadamard transform iDD_2×2 (iDD transform). The DD transform of FIG. 4 may be used to perform the transform at blocks 107, 218 in FIGS. 1 and 2. The iDD transform of FIG. 4 may be used to perform the inverse transform at blocks 115, 314, 329 in FIGS. 1 and 3.

FIG. 4 also illustrates a larger 4×4 residual data block 415 and corresponding 4×4 AHVD coefficients block 420. The 4×4 AHVD coefficients block 420 is derivable from the 4×4 residual data block 415 using a forward 4×4 Hadamard transform DD_4×4 (DDs transform). The 4×4 residual data block 415 is derivable from the 4×4 AHVD coefficients block 420 using a reverse or inversed 4×4 Hadamard transform iDD_4×4 (iDDs transform).

### 2×2 Transforms

To compute a DD transform for the 2×2 residual data block 405 in FIG. 4, the following equations are used:

$$A = {R}_{00} + {R}_{01} + {R}_{10} + {R}_{11} H = {R}_{00} - {R}_{01} + {R}_{10} - {R}_{11} V = {R}_{00} + {R}_{01} - {R}_{10} - {R}_{11} D = {R}_{00} - {R}_{01} - {R}_{10} + {R}_{11}$$

For simplicity, the above equations do not include an averaging factor which would be used to prevent incorrect scaling.

To compute an iDD transform for the 2×2 AHVD coefficients block 410 in FIG. 4, the following equations are used:

$${R}_{00} = A + H + V + D {R}_{01} = A - H + V - D {R}_{10} = A + H - V - D {R}_{11} = A - H - V + D$$

For simplicity, the above equations do not include an averaging factor which would be used to prevent incorrect scaling.

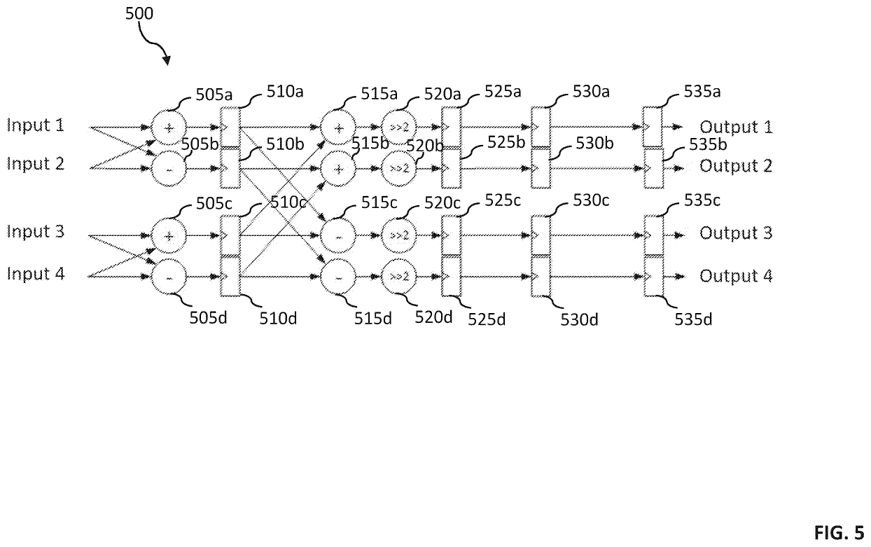

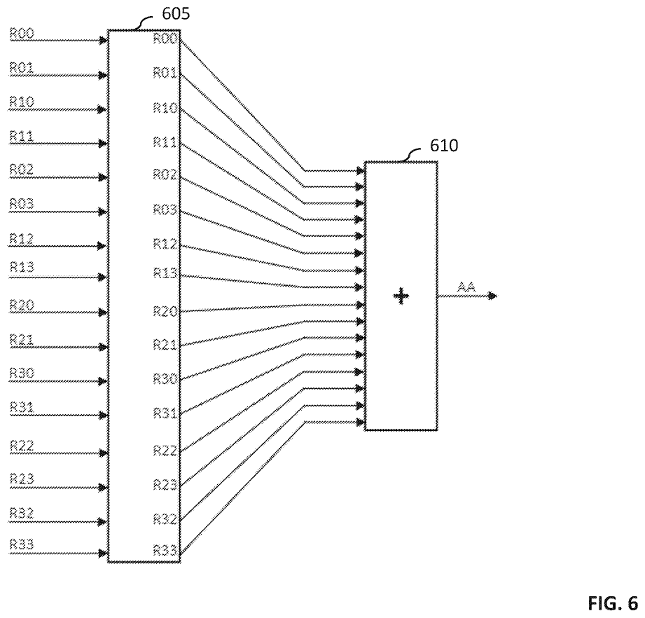

FIG. 5 is a block diagram showing an exemplary hardware arrangement 500 to implement the DD transform or iDD transform of FIG. 4 (the DDs and iDDs transforms at 4×4 are described in relation to FIG. 6 to 9). FIG. 5 shows four inputs going into the hardware arrangement to produce four outputs. The four inputs are input 1, input 2, input 3 and input 4 which may be residual data in the form of R₀₀, R₀₁, R₁₀ and R₁₁ respectively for a DD transform or they may be AHVD coefficients A, B, C and D respectively for an iDD transform. The four outputs are output 1, output 2, output 3 and output 4 which may be AHVD coefficients A, B, C and D respectively for a DD transform or they may be residual data in the form of R₀₀, R₀₁, R₁₀ and R₁₁ respectively for an iDD transform.

In more detail, the hardware arrangement 500 is now described.

Summation block 505a sums input 1 and input 2 and the resulting value is stored in register 510a. Subtraction block 505b subtracts input 2 from input 1 and the resulting value is stored in register 510b. Summation block 505c sums input 3 and input 4 and the resulting value is stored in register 510c. Subtraction block 505d subtracts input 4 from input 3 and the resulting value is stored in register 510d.

Summation block 515a sums the value stored in register 510a and the value stored in register 510c and stores the resulting value in register 525a after passing through shift operator 520a. Summation block 515b sums the value stored in register 510b and the value stored in register 510d and stores the resulting value in register 525b after passing through shift operator 520b. Subtraction block 515c subtracts the value stored in register 510c from the value stored in register 510a and stores the resulting value in register 525c after passing through shift operator 520c. Subtraction block 515d subtracts the value stored in register 510d from the value stored in register 510b and stores the resulting value in register 525d after passing through shift operator 520d. The shift operators 520a-d are optionally used to achieve the correct weights/scale of the resulting output components, for example, a division by 4 may be used to provide an average rather than the absolute summation.

The value stored in register 525a is then forwarded to register 530a and register 535a for storage and output as output 1. The value stored in register 525b is then forwarded to register 530b and register 535b for storage and output as output 2. The value stored in register 525c is then forwarded to register 530c and register 535c for storage and output as output 3. The value stored in register 525d is then forwarded to register 530d and register 535d for storage and output as output 4. These registers may be used for pipelining efficiencies.

One or all of the registers used in FIG. 5 may not be used such that data from the computation blocks (i.e., summation, subtraction and/or shift operator blocks) may be passed from the input through the computation block and directly to the output without being stored in multiple registers.

### 4×4 Transforms

To compute a DDs transform for the 4×4 residual data block 415 in FIG. 4, the following equations are used:

$$AA = {R}_{00} + {R}_{01} + {R}_{02} + {R}_{03} + {R}_{10} + {R}_{11} + {R}_{12} + {R}_{13} + {R}_{20} + {R}_{21} + {R}_{22} + {R}_{23} + {R}_{30} + {R}_{31} + {R}_{32} + {R}_{33} \\ AH = {R}_{00} + {R}_{01} - {R}_{02} - {R}_{03} + {R}_{10} + {R}_{11} - {R}_{12} - {R}_{13} + {R}_{20} + {R}_{21} - {R}_{22} - {R}_{23} + {R}_{30} + {R}_{31} - {R}_{32} - {R}_{33} \\ AV = {R}_{00} + {R}_{01} + {R}_{02} + {R}_{03} + {R}_{10} + {R}_{11} + {R}_{12} + {R}_{13} - {R}_{20} - {R}_{21} - {R}_{22} - {R}_{23} - {R}_{30} - {R}_{31} - {R}_{32} - {R}_{33} \\ AD = {R}_{00} + {R}_{01} - {R}_{02} - {R}_{03} + {R}_{10} + {R}_{11} - {R}_{12} - {R}_{13} - {R}_{20} - {R}_{21} + {R}_{22} + {R}_{23} - {R}_{30} - {R}_{31} + {R}_{32} + {R}_{33} \\ HA = {R}_{00} - {R}_{01} + {R}_{02} - {R}_{03} + {R}_{10} - {R}_{11} + {R}_{12} - {R}_{13} + {R}_{20} - {R}_{21} + {R}_{22} - {R}_{23} + {R}_{30} - {R}_{31} + {R}_{32} - {R}_{33} \\ HH = {R}_{00} - {R}_{01} - {R}_{02} + {R}_{03} + {R}_{10} - {R}_{11} - {R}_{12} + {R}_{13} + {R}_{20} - {R}_{21} - {R}_{22} + {R}_{23} + {R}_{30} - {R}_{31} - {R}_{32} + {R}_{33} \\ HV = {R}_{00} - {R}_{01} + {R}_{02} - {R}_{03} + {R}_{10} - {R}_{11} + {R}_{12} - {R}_{13} - {R}_{20} + {R}_{21} - {R}_{22} + {R}_{23} - {R}_{30} + {R}_{31} - {R}_{32} + {R}_{33} \\ HD = {R}_{00} - {R}_{01} - {R}_{02} + {R}_{03} + {R}_{10} - {R}_{11} - {R}_{12} + {R}_{13} - {R}_{20} + {R}_{21} + {R}_{22} - {R}_{23} - {R}_{30} + {R}_{31} + {R}_{32} - {R}_{33} \\ VA = {R}_{00} + {R}_{01} + {R}_{02} + {R}_{03} - {R}_{10} - {R}_{11} - {R}_{12} - {R}_{13} + {R}_{20} + {R}_{21} + {R}_{22} + {R}_{23} - {R}_{30} - {R}_{31} - {R}_{32} - {R}_{33} \\ VH = {R}_{00} + {R}_{01} - {R}_{02} - {R}_{03} - {R}_{10} - {R}_{11} + {R}_{12} + {R}_{13} + {R}_{20} + {R}_{21} - {R}_{22} - {R}_{23} - {R}_{30} - {R}_{31} + {R}_{32} + {R}_{33} \\ VV = {R}_{00} + {R}_{01} + {R}_{02} + {R}_{03} - {R}_{10} - {R}_{11} - {R}_{12} - {R}_{13} - {R}_{20} - {R}_{21} - {R}_{22} - {R}_{23} + {R}_{30} + {R}_{31} + {R}_{32} + {R}_{33} \\ VD = {R}_{00} + {R}_{01} - {R}_{02} - {R}_{03} - {R}_{10} - {R}_{11} + {R}_{12} + {R}_{13} - {R}_{20} - {R}_{21} + {R}_{22} + {R}_{23} + {R}_{30} + {R}_{31} - {R}_{32} - {R}_{33} \\ DA = {R}_{00} - {R}_{01} + {R}_{02} - {R}_{03} - {R}_{10} + {R}_{11} - {R}_{12} + {R}_{13} + {R}_{20} - {R}_{21} + {R}_{22} - {R}_{23} - {R}_{30} + {R}_{31} - {R}_{32} + {R}_{33} \\ DH = {R}_{00} - {R}_{01} - {R}_{02} + {R}_{03} - {R}_{10} + {R}_{11} + {R}_{12} - {R}_{13} + {R}_{20} - {R}_{21} - {R}_{22} + {R}_{23} - {R}_{30} + {R}_{31} + {R}_{32} - {R}_{33} \\ DV = {R}_{00} - {R}_{01} + {R}_{02} - {R}_{03} - {R}_{10} + {R}_{11} - {R}_{12} + {R}_{13} - {R}_{20} + {R}_{21} - {R}_{22} + {R}_{23} + {R}_{30} - {R}_{31} + {R}_{32} - {R}_{33} \\ DD = {R}_{00} - {R}_{01} - {R}_{02} + {R}_{03} - {R}_{10} + {R}_{11} + {R}_{12} - {R}_{13} - {R}_{20} + {R}_{21} + {R}_{22} - {R}_{23} + {R}_{30} - {R}_{31} - {R}_{32} + {R}_{33}$$

For simplicity, the above equations do not include an averaging factor which would be used to prevent incorrect scaling.

To compute an iDDs transform for the 4×4 AHVD coefficients block 420 in FIG. 4, the following equations are used:

$${R}_{00} = AA + AH + AV + AD + HA + HH + HV + HD + VA + VH + VV + VD + DA + DH + DV + DD \\ {R}_{01} = AA + AH - AV - AD + HA + HH - HV - HD + VA + VH - VV - VD + DA + DH - DV - DD \\ {R}_{02} = AA - AH + AV - AD + HA - HH + HV - HD + VA - VH + VV - VD + DA - DH + DV - DD \\ {R}_{03} = AA - AH - AV + AD + HA - HH - HV + HD + VA - VH - VV + VD + DA - DH - DV + DD \\ {R}_{10} = AA + AH + AV + AD + HA + HH + HV + HD - VA - VH - VV - VD - DA - DH - DV - DD \\ {R}_{11} = AA + AH - AV - AD + HA + HH - HV - HD - VA - VH + VV + VD - DA - DH + DV + DD \\ {R}_{12} = AA - AH + AV - AD + HA - HH + HV - HD - VA + VH - VV + VD - DA + DH - DV + DD \\ {R}_{13} = AA - AH - AV + AD + HA - HH - HV + HD - VA + VH + VV - VD - DA + DH + DV - DD \\ {R}_{20} = AA + AH + AV + AD - HA - HH - HV - HD + VA + VH + VV + VD - DA - DH - DV - DD \\ {R}_{21} = AA + AH - AV - AD - HA - HH + HV + HD + VA + VH - VV - VD - DA - DH + DV + DD \\ {R}_{22} = AA - AH + AV - AD - HA + HH - HV + HD + VA - VH + VV - VD - DA + DH - DV + DD \\ {R}_{23} = AA - AH - AV + AD - HA + HH + HV - HD + VA - VH - VV + VD - DA + DH + DV - DD \\ {R}_{30} = AA + AH + AV + AD - HA - HH - HV - HD - VA - VH - VV - VD + DA + DH + DV + DD \\ {R}_{31} = AA + AH - AV - AD - HA - HH + HV + HD - VA - VH + VV + VD + DA + DH - DV - DD \\ {R}_{32} = AA - AH + AV - AD - HA + HH - HV + HD - VA + VH - VV + VD + DA - DH + DV - DD \\ {R}_{33} = AA - AH - AV + AD - HA + HH + HV - HD - VA + VH + VV - VD + DA - DH - DV + DD$$

For simplicity, the above equations do not include an averaging factor which would be used to prevent incorrect scaling.

FIG. 6 illustrates possible hardware blocks which may be used to perform the operation of converting the residual data to AHVD coefficient AA. The residual data are received at receiving block 605. From receiving block 605, the residual data are summed at computation block 610 to compute AHVD coefficient AA. Although, in this example, the residual data are initially received at receiving block 605 before they are passed to the computation block 610, in other examples, the receiving block 605 may not be used and the residual data may be received directly at the computation block 610.

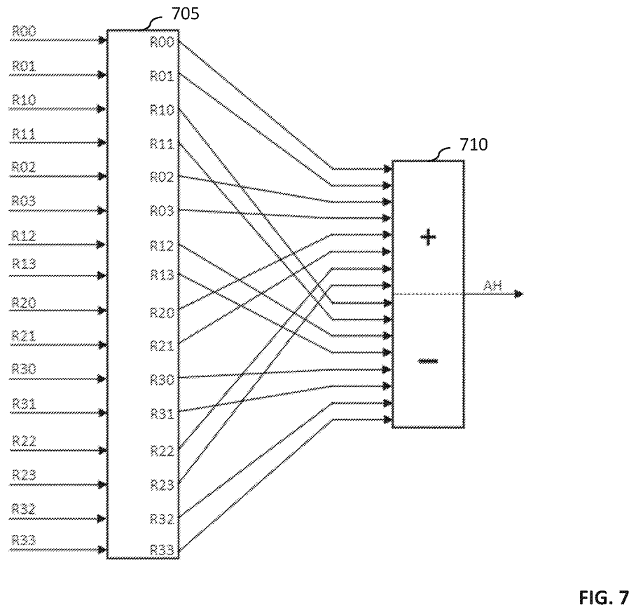

FIG. 7 illustrates possible hardware blocks which may be used to perform the operation of converting the residual data to AHVD coefficient AH. The residual data are received at receiving block 705. From receiving block 705, residual data R₁₀, R₁₁, R₁₂, R₁₃, R₃₀, R₃₁, R₃₂ and R₃₃ are subtracted from the sum of residual data R₀₀, R₀₁, R₀₂, R₀₃, R₂₀, R₂₁, R₂₂ and R₂₃ to compute AHVD coefficient AA. Although, in this example, the residual data are initially received at receiving block 705 before they are passed to computation block 710, in other examples, the receiving block 705 may not be used and the residual data may be received directly at computation block 710.

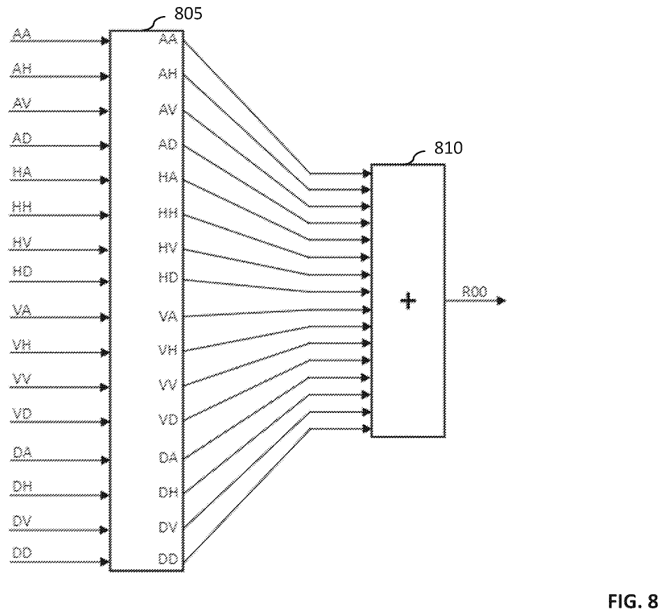

FIG. 8 illustrates possible hardware blocks which may be used to perform the operation of converting AHVD_4×4 coefficients to residual data R₀₀, in other words performing part of an iDDs. The hardware shown in FIG. 8 is the hardware of FIG. 6. The AHVD_4×4 coefficients are received at receiving block 805. From receiving block 805, the AHVD_4×4 coefficients are summed at computation block 810 to compute residual data R₀₀. Although, in this example, the AHVD_4×4 coefficients are initially received at receiving block 805 before they are passed to computation block 810, in other examples, the receiving block 805 may not be used and the AHVD_4×4 coefficients may be received directly at computation block 810.

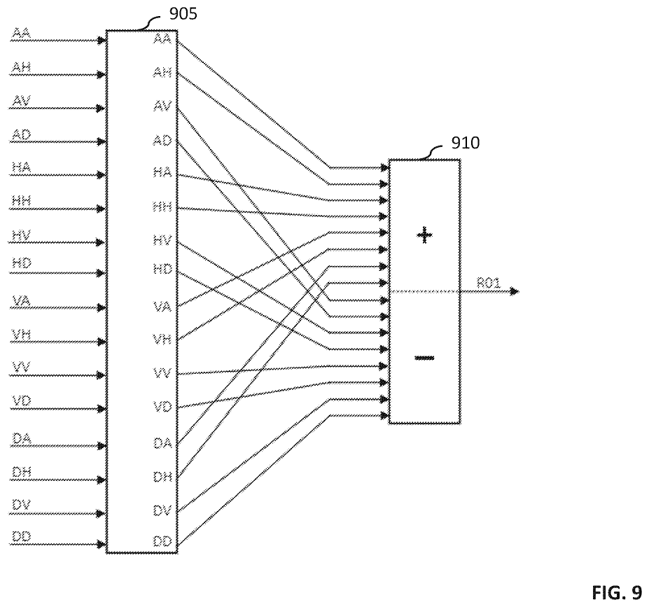

FIG. 9 illustrates possible hardware blocks which may be used to perform the operation of converting AHVD_4×4 coefficients to residual data R₀₁. The hardware shown in FIG. 9 is the hardware of FIG. 7. The AHVD_4×4 coefficients are received at receiving block 905. From receiving block 905, AHVD_4×4 coefficients AV, AD, HV, HD, VV, VD, DV and DD are subtracted from the sum of AHVD_4×4 coefficients AA, AH, HA, HH, VA, VH, DA and DH to compute residual data R₀₁. Although, in this example, the AHVD_4×4 coefficients are initially received at receiving block 905 before they are passed to computation block 910, in other examples, the receiving block 905 may not be used and the AHVD_4×4 coefficients may be received directly at computation block 910.

To convert AHVD_4×4 coefficients to a 4×4 block of residual data or vice versa, 16 different blocks (similar to the ones shown in FIGS. 6 to 9) will be necessary to perform the 16 equations shown above to produce residual data R₀₀ to R₃₃ or AHVD_4×4 coefficients AA to DD. The use of 16 different blocks to perform 16 different mathematical operations translates to high costs in terms of resources (e.g., physical area for the hardware) and processing time. Furthermore, each block needs to perform 15 additions or subtractions.

This may make it difficult to complete the operation at each block within a single clock cycle or other desired time constraint. Therefore, there is a need for optimisation of the above approach of performing transforms.

Another problem also arises based on the type of transform used (2×2 DD or 4×4 DDs) which can change between frames (and even within a frame), therefore, it is a challenge to provide an encoder/decoder with the ability to use the same hardware to perform both the DD and the DDs transforms. It is less efficient if the encoder/decoder needs separate hardware to do 2×2 DD/iDD transforms and 4×4 iDDs/DDs transforms.

Therefore, the disclosure herein has an aim to provide a modular piece of hardware that can be used in all DD, iDD, DDs and iDDs implementations, and which can reduce the number of computations in a single hardware block to process the transform more quickly.

The modular piece of hardware has been derived as follows:

The iDDs transform equations are as follows:

$${R}_{00} = AA + AH + AV + AD + HA + HH + HV + HD + VA + VH + VV + VD + DA + DH + DV + DD \\ {R}_{01} = AA + AH - AV - AD + HA + HH - HV - HD + VA + VH - VV - VD + DA + DH - DV - DD \\ {R}_{02} = AA - AH + AV - AD + HA - HH + HV - HD + VA - VH + VV - VD + DA - DH + DV - DD \\ {R}_{03} = AA - AH - AV + AD + HA - HH - HV + HD + VA - VH - VV + VD + DA - DH - DV + DD \\ {R}_{10} = AA + AH + AV + AD + HA + HH + HV + HD - ( VA + VH + VV + VD ) - ( DA + DH + DV + DD ) \\ {R}_{11} = AA + AH - AV - AD + HA + HH - HV - HD - ( VA + VH - VV - VD ) - ( DA + DH - DV - DD ) \\ {R}_{12} = AA - AH + AV - AD + HA - HH + HV - HD - ( VA - VH + VV - VD ) - ( DA - DH + DV - DD ) \\ {R}_{13} = AA - AH - AV + AD + HA - HH - HV + HD - ( VA - VH - VV + VD ) - ( DA - DH - DV + DD ) \\ {R}_{20} = AA + AH + AV + AD - ( HA + HH + HV + HD ) + VA + VH + VV + VD - ( DA + DH + DV + DD ) \\ {R}_{21} = AA + AH - AV - AD - ( HA + HH - HV - HD ) + VA + VH - VV - VD - ( DA + DH - DV - DD ) \\ {R}_{22} = AA - AH + AV - AD - ( HA - HH + HV - HD ) + VA - VH + VV - VD - ( DA - DH + DV - DD ) \\ {R}_{23} = AA - AH - AV + AD - ( HA - HH - HV + HD ) + VA - VH - VV + VD - ( DA - DH - DV + DD ) \\ {R}_{30} = AA + AH + AV + AD - ( HA + HH + HV + HD ) - ( VA + VH + VV + VD ) + DA + DH + DV + DD \\ {R}_{31} = AA + AH - AV - AD - ( HA + HH - HV - HD ) - ( VA + VH - VV - VD ) + DA + DH - DV - DD \\ {R}_{32} = AA - AH + AV - AD - ( HA - HH + HV - HD ) - ( VA - VH + VV - VD ) + DA - DH + DV - DD \\ {R}_{33} = AA - AH - AV + AD - ( HA - HH - HV + HD ) - ( VA - VH - VV + VD ) + DA - DH - DV + DD$$

If we analyse the signs of the equations above, we can distinguish a consistent pattern of algebraic operations that can be further simplified:

$$J = A + H + V + D K = A + H - V - D L = A - H + V - D M = A - H - V + D$$

Thus, the above system of equations representing all the residuals, can be finally expressed as follows:

$${R}_{00} = AJ + HJ + VJ + DJ \\ {R}_{10} = AJ + HJ - VJ - DJ \\ {R}_{20} = AJ - HJ + VJ - DJ \\ {R}_{30} = AJ - HJ - VJ + DJ \\ {R}_{01} = AK + HK + VK + DK \\ {R}_{11} = AK + HK - VK - DK \\ {R}_{21} = AK - HK + VK - DK \\ {R}_{31} = AK - HK - VK + DK \\ {R}_{02} = AL + HL + VL + DL \\ {R}_{12} = AL + HL - VL - DL \\ {R}_{22} = AL - HL + VL - DL \\ {R}_{32} = AL - HL - VL + DL \\ {R}_{03} = AM + HM + VM + DM \\ {R}_{13} = AM + HM - VM - DM \\ {R}_{23} = AM - HM + VM - DM \\ {R}_{33} = AM - HM - VM + DM$$

By analysing the equations introduced thus far, it can be observed that there is a repeated pattern of operations to compute iDDs transform, which mimics the iDD transform, and that can be exploited to apply modularity and reusability of blocks in the design.

For example, compare

$$J = A + H + V + D \\ K = A + H - V - D \\ L = A - H + V - D \\ M = A - H - V + D \\ with$$

$${R}_{00} = A + H + V + D \\ {R}_{01} = A - H + V - D \\ {R}_{10} = A + H - V - D \\ {R}_{11} = A - H - V + D$$

Thus, the iDD and iDDs transforms can be reduced to common terms for modularized architecture. Furthermore, the terms involved in the iDDs can be rearranged and then expressed as expressions that correspond to the output of the DD/iDD.

The repeated pattern of operations to compute iDDs, which mimics the iDD transform, can be exploited to apply modularity and reusability of blocks in the design. Modular implementation advantageously allows the re-use of the same structure for computing both 2×2 and 4×4 transforms.

While this has been shown above for the iDDs and iDD relationship, similar applies to the DDs and DD relationship.

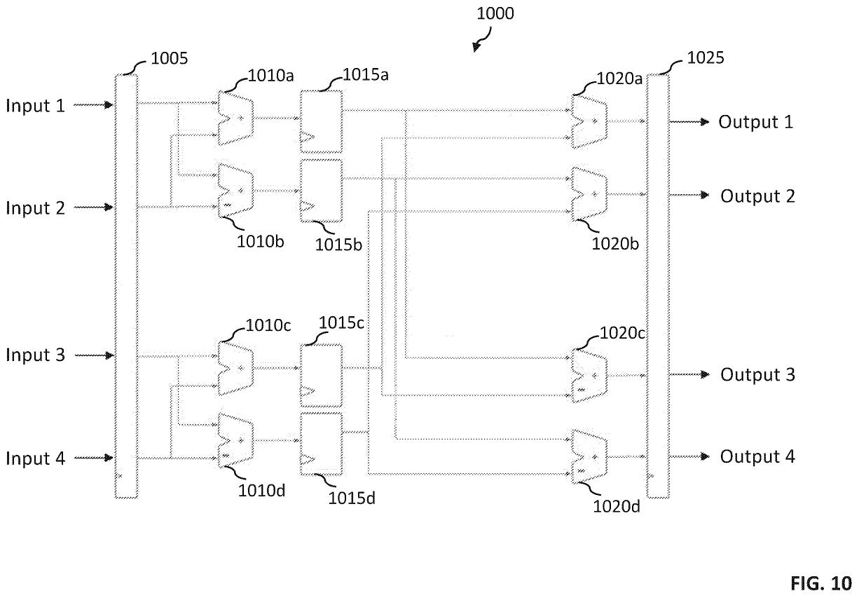

FIG. 10 illustrates a modular design of a dd_common module 1000. FIG. 10 shows four inputs going into the hardware arrangement to produce four outputs. The four inputs are input 1, input 2, input 3 and input 4 which may be residual data for a forward transform, or they may be AHVD coefficients for a backward or inverse transform. The four outputs are output 1, output 2, output 3 and output 4 which may be AHVD coefficients for a forward transform or they may be residual data for a backward or inverse transform.

Input register 1005 receives input 1, input 2, input 3 and input 4. Summation block 1010a sums input 1 and input 2 and the resulting value is stored in register 1015a. Subtraction block 1010b subtracts input 2 from input 1 and the resulting value is stored in register 1015b. Summation block 1010c sums input 3 and input 4 and the resulting value is stored in register 1015c. Subtraction block 1010d subtracts input 4 from input 3 and the resulting value is stored in register 1015d.

Summation block 1020a sums the value stored in register 1015a and the value stored in register 1015c and forwards the resulting value to output register 1025 to provide output 1. Summation block 1020b sums the value stored in register 1015b and the value stored in register 1015d and forwards the resulting value to output register 1025 to provide output 2. Subtraction block 1020c subtracts the value stored in register 1015c from the value stored in register 1015a and forwards the resulting value to output register 1025 to provide output 3. Subtraction block 1020d subtracts the value stored in register 1015d from the value stored in register 1015b and forwards the resulting value to output register 1025 to provide output 4.

The registers used in FIG. 10 are optional and may not be used such that data from the computation blocks (i.e., summation and subtraction blocks) is passed from the input through to the output without being stored in the registers.

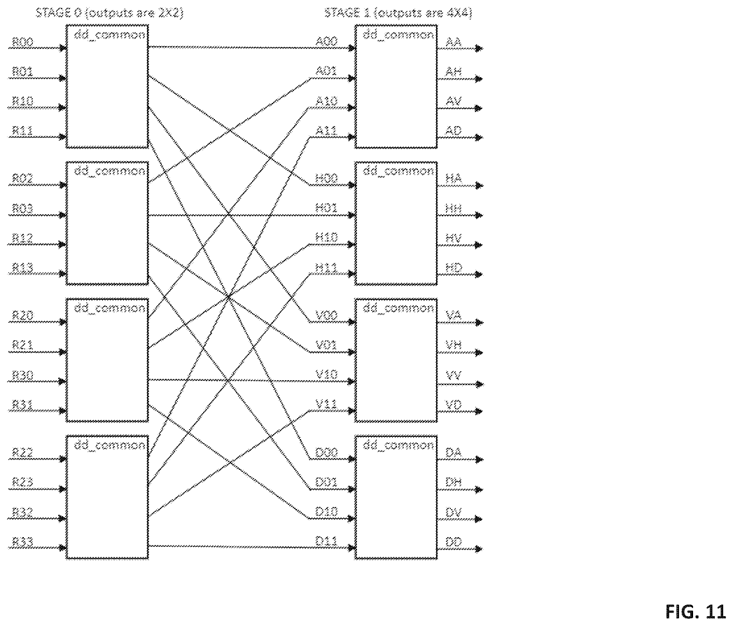

FIG. 11 illustrates dd_common modules arranged to perform a DDs transform. FIG. 11 shows 8 dd_common modules (reference 1000 in FIG. 10) to perform the DDs transform, which is half the number of modules/blocks that would be needed if the arrangement of FIGS. 6 to 9 is used. Each individual dd_common module performs a 2×2 DD transform but the combination of all the modules allows for a 4×4 DDs transform to take place.

The dd_common module arrangement of FIG. 11 is arranged in two stages to ensure an efficient computation of 4×4 transforms. The arrangement of FIG. 11 comprises a first stage (stage 0) and a second stage (stage 1). Stage 0 comprises 4 dd_common modules and stage 1 comprises 4 dd_common modules. Each of the stage 0 modules are connected to each of the stage 1 modules as can be seen in FIG. 11. Each dd_common module of stage 0 receives 4 inputs and outputs 4 intermediate values. In this example, the 4 inputs to each dd_common module of stage 0 are residual values to be transformed. Each dd_common block of stage 1 receives the 4 intermediate values outputted by stage 0 dd_common blocks and outputs AHVD coefficients. The arrangement also allows for the computation of 2×2 transforms, as will be discussed below.

In the example of FIG. 11, the inputs to stage 0 are 4×4 residuals (i.e., R₀₀ to R₃₃ data). The outputs 1-4 of stage 0, the intermediate values), are labelled x00, x01, x10 and x11 respectively (where x denotes the first letter of the two letter form of the second order transform elements (AHVD_4×4) that are ultimately output from stage 1. For example, in FIG. 11, a first dd_common module in stage 1 is arranged to be x=A, so its inputs are intermediate values A00, A01, A10 and A11). Stage 1 outputs the AHVD_4×4 transform coefficients (i.e., AA to DD). Therefore, the final AHVD_4×4 transform coefficients are obtained at the output of stage 1 (second stage) taking into account the outputs from the first stage.

A discussion of a 4×4 transform is provided below in more detail with reference to FIGS. 10 and 11.

Inputs R₀₀, R₀₁, R₁₀ and R₁₁, are received at a first dd_common module of the dd_common module arrangement at stage 0 as inputs 1-4 respectively, to produce intermediate outputs A00, H00, V00 and D00 as outputs 1-4 respectively. Intermediate values A00, H00, V00 and D00 each act as input 1 to respective dd_common modules of stage 1.

Inputs R₀₂, R₀₃, R₁₂ and R₁₃, are received at a second dd_common module of the dd_common module arrangement at stage 0 as inputs 1-4 respectively, to produce intermediate outputs A01, H01, V01 and D01 as outputs 1-4 respectively. Intermediate values A01, H01, V01 and D01 each act as input 2 to respective dd_common modules of stage 1.

Inputs R₂₀, R₂₁, R₃₀ and R₃₁, are received at a third dd_common module of the dd_common module arrangement at stage 0 as inputs 1-4 respectively, to produce intermediate outputs A10, H10, V10 and D10 as outputs 1-4 respectively. Intermediate values A10, H10, V10 and D10 act as input 3 to respective dd_common modules of stage 1.

Inputs R₂₂, R₂₃, R₃₂ and R₃₃, are received at a fourth dd_common module of the dd_common module arrangement at stage 0 as inputs 1-4 respectively, to produce intermediate values A11, H11, V11 and D11 as outputs 1-4 respectively. Intermediate outputs A11, H11, V11 and D11 act as input 4 to respective dd_common modules of stage 1.

At stage 1, a fifth dd_common module (the first dd_common module in stage 1 referred to above) receives intermediate values A00, A01, A10 and A11 as inputs 1-4 respectively, to produce outputs AA, AH, AV and AD as outputs 1-4 respectively.

At stage 1, a sixth dd_common module receives intermediate values H00, H01, H10 and H11 as inputs 1-4 respectively, to produce outputs HA, HH, HV and HD as outputs 1-4 respectively.

At stage 1, a seventh dd_common module receives intermediate values V00, V01, V10 and V11 as inputs 1-4, to produce outputs VA, VH, VV and VD as outputs 1-4 respectively.

At stage 1, an eighth dd_common module receives intermediate values D00, D01, D10 and D11 as inputs 1-4 respectively, to produce outputs DA, DH, DV and DD as outputs 1-4 respectively.

In this example, each intermediate value received at a stage 1 dd_common module is received from a different stage 0 dd_common module. However, in other examples, multiple intermediate values received at a stage 1 dd_common module are received from the same stage 0 dd_common module.

In the case of a 2×2 transform being performed, the outputs of each dd_common module in stage 0 would be the AHVD_2×2 coefficients obtained as result of a DD transform operation e.g., A=R₀₀+R₀₁+R₁₀+R₁₁, H=R₀₀−R₀₁+R₁₀−R₁₁, V=R₀₀+R₀₁−R₁₀−R₁₁ and A=R₀₀−R₀₁−R₁₀+R₁₁. When performing a 2×2 transform, the outputs of one or each of the dd_common modules of stage 0 are outputted directly (not shown in FIG. 11) for further processing or storage as AHVD_2×2 coefficients. Not all the modules of stage 0 need to be used, for example, only the dd_common module associated with R₀₀, R₀₁, R₁₀ and R₁₁ may be used to produce corresponding AHVD_2×2 coefficients for output. Using all of the stage 0 dd_common modules to perform separate 2×2 transforms in parallel is advantageous at least in terms of efficiently using the hardware. In an example, a stage 0 dd-common module may perform a 2×2 transform on its input, and outputs the results directly for further processing or storage (optionally without sending the outputs to stage 1 dd-common modules) based on an indicator. Optionally, the indicator may be received at the hardware block or the relevant stage 0 dd-common module with the input data or separately. Optionally the indicator may be obtained from a received bitstream (in embodiments this may be a bytestream).

Arranging multiple dd_common modules in the way illustrated in FIG. 11 allows for a system that can be used for DD and DDs transforms and minimises hardware resources by reducing DD and DDs transforms to common terms for a modularized architecture.

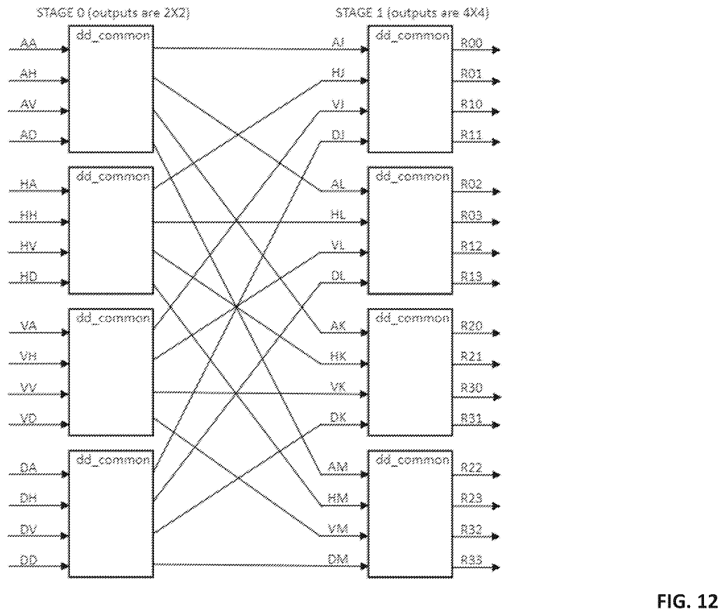

FIG. 12 illustrates the dd_common modules arrangement of FIG. 11 in an example where an iDDs transform is performed. To perform an inverse transform, the same dd_common module arrangement used in FIG. 11 can be used.

In the example of FIG. 12, the inputs to stage 0 are ‘second order transform elements’ or AHVD_4×4 coefficients (i.e., AA to DD data). The outputs of stage 0/input of stage 1 (i.e., the intermediate values) are xJ, xL, xK and xM (where x denotes the first letter of the two letter form of the second order transform elements, for example, in FIG. 12, the top left or first dd_common has x=A, so it outputs AJ, AL, AK and AM). The output of stage 1 is residual data (i.e., R₀₀-R₃₃).

In the case of a 2×2 inverse transform being performed, the inputs to stage 0 are ‘first order transform elements’ or AHVD_2×2 coefficients (i.e. A, H, V and D data) and the outputs 1-4 of each dd_common module are 4 residual values respectively e.g., R₀₀=A+H+V+D, R₀₁=A−H+V−D, R₁₀=A+H−V−D and R₁₁=A−H−V+D.

As can be seen from the description of FIGS. 11 and 12, a 4×4 transform requires two banks of four dd_common modules whereas a 2×2 transform is achieved with a single dd_common module (as discussed in FIGS. 11 and 12). A dd_common module/block is defined as a module configured to receive 4 inputs and produce 4 outputs, wherein if the 4 inputs are first order transform elements such as A, H, V, D, then the 4 outputs are a 2×2 block of residuals, wherein if the 4 inputs are part of a group of second order transform elements such as AHVD_4×4 elements AA, AH, etc. arranged as in FIG. 12, then the output at stage 0 is a set of intermediate values and the subsequent stage, stage 1, is used to obtain and output the 4×4 residual values. Clearly, if the inputs to stage 0 are 4×4 residual values then the outputs at stage 1 will be AHVD_4×4 transform elements.

The novel dd_common module and arrangement disclosed herein increases throughput and reduces hardware components.

Rather than a single stage of 16 computation blocks, the invention uses a first stage having 4 modules connected to a second stage having 4 modules. In this example, each module is modular (i.e., it processes data in the same way). An inventive aspect of the invention is how to route/connect each output of each of the modules in the first stage (‘intermediate output’) to the ‘correct’ module in the second stage to achieve the desired final outputs.

The intermediate outputs (i.e., outputs from the first stage) correspond to the final output of DD/iDD transforms, which means a single architecture can be used for DD/iDD transforms and for DDs/iDDs transforms.

Throughput is increased because (in the most complex example, iDDs or DDs) each final output only takes the time of 4 additions (although there are 8 additions in each module, they are carried out as 4 performed in parallel and then another 4 in parallel, so in terms of processing time it is the same as 2 additions within the dd_common block. There are then 2 stages of modules. Thus, the total ‘time’ is the same as 4 additions) rather than (a single set of) 15 additions in the examples of FIGS. 6 to 9 which would require the total ‘time’ of 15 additions. The more elements to add, the longer it takes to do, thus a reduction from 15 to 4 reduces the time to generate the output. A smaller time per output increases throughput because more outputs can be produced in a given time. Rather than using a single set of 15 additions to process 16 inputs as shown in the examples of FIGS. 6 to 9, a 16 input tree structure may be used which may comprise four stages of additions in this instance (i.e., A+B, C+D etc resulting in 8 outputs for stage 1, followed by 4 outputs at stage 2 and so on). Using a tree structure would results in an increase of throughput but with the downside of increasing the number of logical resources used. However, the disclosure herein allows for an increase in throughput and a drastic reduction in logical resources required.

Now looking at the computation of the entire iDDs or DDs transform, 8 dd_common modules are needed which require 64 additions (8 additions in each dd_common module and there are 8 dd_common modules). The additions are then performed 16 in parallel followed by 16 in parallel to complete stage 0 additions so in terms of processing time it is the same as 2 additions. Taking into account the stage 1 modules leads to a total processing time that is the same as 4 additions. On the contrary, to compute the entire iDDs or DDs transform, 16 blocks each having 15 additions would be necessary (totaling 240 additions). However, the additions of the 16 blocks may run in parallel resulting in a total ‘time’ of 15 additions to compute the entire iDDs or DDs transform.

Furthermore, hardware components are reduced because, for the most complex calculation (iDDs or DDs transforms), only 8 adder blocks (dd_common modules) are needed, rather than 16 adder blocks needed in the examples of FIGS. 6 to 9. If stage 0 adder modules are reused, then only 4 adder modules would be needed in total to compute iDDs or DDs transforms. When reusing stage 0 modules as stage 1 modules, the output of the set of modules when they are at stage 0 are routed back into said set of modules to undergo the subsequent stage 1 operation.

The above embodiments are to be understood as illustrative examples. Further embodiments are envisaged. It is to be understood that any feature described in relation to any one embodiment may be used alone or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A hardware block for converting input data elements representing image data in a first format to output data elements representing image data in a second format; wherein the hardware block comprises:
a plurality of modules organised into a first group of modules and a second group of modules, wherein the first group of modules and the second group of modules each comprise four modules, wherein each module of the first group of modules is configured to:
receive a subset of the input data elements representing image data in the first format; and
perform a plurality of operations to convert the subset of the input data elements representing image data in the first format to intermediate elements, wherein each intermediate element is derived from the subset of the input data elements representing image data in the first format using one of the plurality of operations; and wherein each module of the second group of modules is configured to:
receive a subset of the intermediate elements, wherein each intermediate element of the received subset of the intermediate elements is from a different module of the first group of modules; and
perform the plurality of operations to convert the subset of the intermediate elements to a subset of the output data elements representing image data in the second format.

2. The hardware block of claim 1, wherein each intermediate element is derived from the subset of the input data elements representing image data in the first format using a distinct one of the plurality of operations.

3. The hardware block of claim 2, wherein each received subset of the intermediate elements is derived from the subset of the input data elements representing image data in the first format using the same distinct one of the plurality operations.

4. The hardware block of claim 1, wherein the input data elements representing image data in the first format are residual elements and the output data elements representing image data in the second format are a set of transformed elements indicative of an extent of spatial correlation in the residual elements.

5. The hardware block of claim 1, wherein the output data elements representing image data in the second format are residual elements and the input data elements representing image data in the first format are a set of transformed elements indicative of an extent of spatial correlation in the residual elements.

6. The hardware block of claim 4, wherein the set of transformed elements indicate one or more of average, horizontal, vertical and diagonal relationship between neighbouring residual elements.

7. The hardware block of claim 6, wherein the set of transformed elements are based on a Hadamard direct decomposition transform.

8. The hardware block of claim 4, wherein the residual elements are based on a difference between a first rendition of an image associated with the image data at a level of quality in a tiered hierarchy having multiple levels of quality and a second rendition of the image at the same level of quality.

9. The hardware block of claim 1, wherein each of the plurality of operations perform a multi-dimensional Hadamard direct decomposition transform.

10. The hardware block of claim 1, wherein the subset of the input data elements representing image data in the first format and subset of the output data elements representing image data in the second format each comprise four data elements.

11. The hardware block of claim 1, wherein the first group of modules and the second group of modules are the same.

12. The hardware block of claim 1, wherein the intermediate element derived in at least one module of the first group of modules is outputted from the hardware block.

13. A method for converting input data elements representing image data in a first format to output data elements representing image data in a second format;
wherein the method comprises using a plurality of modules organised into a first group of modules and a second group of modules, wherein the first group of modules and the second group of modules each comprise four modules, wherein the method further comprises at each module of the first group of modules:
receiving a subset of the input data elements representing image data in the first format; and
performing a plurality of operations to convert the subset of the input data representing image data elements in the first format to intermediate elements, wherein each intermediate element is derived from the subset of the input data elements representing image data in the first format using one of the plurality of operations; and
wherein the method further comprises at each module of the second group of modules:
receiving a subset of the intermediate elements, wherein each intermediate element of the received subset of the intermediate elements is from a different module of the first group of modules; and
performing the plurality of operations to convert the subset of the intermediate elements to a subset of the output data elements representing image data in the second format.

14. The method of claim 13, wherein each intermediate element is derived from the subset of the input data elements representing image data in the first format using a distinct one of the plurality of operations.

15. The method of claim 14, wherein each received subset of the intermediate elements is derived from the subset of the input data elements representing image data in the first format using the same distinct one of the plurality operations.

16. The method of claim 13, wherein the input data elements representing image data in the first format are residual elements and the output data elements representing image data in the second format are a set of transformed elements indicative of an extent of spatial correlation in the residual elements.

17. The method of claim 13, wherein the output data elements representing image data in the second format are residual elements and the input data elements representing image data in the first format are a set of transformed elements indicative of an extent of spatial correlation in the residual elements.

18. The method of claim 16, wherein the set of transformed elements indicate one or more of average, horizontal, vertical and diagonal relationship between neighbouring residual elements.

19. The method of claim 18, wherein the set of transformed elements are based on a Hadamard direct decomposition transform.

20. The method of claim 16, wherein the residual elements are based on a difference between a first rendition of an image associated with the image data at a level of quality in a tiered hierarchy having multiple levels of quality and a second rendition of the image at the same level of quality.

21-24. (canceled)
